(19) United States
(12) Patent Application Publication
(10) Pub. No.: US 2022/0036150 A1
(43) Pub. Date: Feb. 3, 2022

(54) SYSTEM AND METHOD FOR SYNTHESIS OF COMPACT AND ACCURATE NEURAL NETWORKS (SCANN)

(71) Applicant: The Trustees of Princeton University, Princeton, NJ (US)

(72) Inventors: Shayan HASSANTABAR, Ewing, NJ (US); Zeyu WANG, Princeton, NJ (US); Niraj K. JHA, Princeton, NJ (US)

(73) Assignee: The Trustees of Princeton University, Princeton, NJ (US)

(21) Appl. No.: 17/275,949

(22) PCT Filed: Jul. 12, 2019
(86) PCT No.: PCT/US2019/041531

§ 371 Date: Mar. 12, 2021

Related U.S. Application Data
(60) Provisional application No. 62/732,620, filed on Sep. 18, 2018.
(60) Provisional application No. 62/835,694, filed on Apr. 18, 2019.

(51) Int. Cl. G06N 3/04; G06N 3/08

(52) U.S. Cl. CPC G06N 3/04; G06N 3/082

(57) ABSTRACT

According to various embodiments, a method for generating a compact and accurate neural network for a dataset is disclosed. The method includes providing an initial neural network architecture; performing a dataset modification on the dataset, the dataset modification including reducing dimensionality of the dataset; performing a first compression step on the initial neural network architecture that results in a compressed neural network architecture, the first compression step including reducing a number of neurons in one or more layers of the initial neural network architecture based on a feature compression ratio determined by the reduced dimensionality of the dataset; and performing a second compression step on the compressed neural network architecture, the second compression step including one or more of iteratively growing connections, growing neurons, and pruning connections until a desired neural network architecture has been generated.

### CROSS-REFERENCE TO RELATED APPLICATIONS

This application claims priority to provisional applications 62/732,620 and 62/835,694, filed Sep. 18, 2018 and Apr. 18, 2019, respectively, which are herein incorporated by reference in their entirety.

### STATEMENT REGARDING FEDERALLY SPONSORED RESEARCH OR DEVELOPMENT

This invention was made with government support under Grant #CNS-1617640 awarded by the National Science Foundation. The government has certain rights in the invention.

### FIELD OF THE INVENTION

The present invention relates generally to neural networks and, more particularly, to a neural network synthesis system and method that can generate compact neural networks without loss in accuracy.

### BACKGROUND OF THE INVENTION

Artificial neural networks (ANNs) have a long history, dating back to 1950's. However, interest in ANNs has waxed and waned over the years. The recent spurt in interest in ANNs is due to large datasets becoming available, enabling ANNs to be trained to high accuracy. This trend is also due to a significant increase in compute power that speeds up the training process. ANNs demonstrate very high classification accuracies for many applications of interest, e.g., image recognition, speech recognition, and machine translation. ANNs have also become deeper, with tens to hundreds of layers. Thus, the phrase ‘deep learning’ is often associated with such neural networks. Deep learning refers to the ability of ANNs to learn hierarchically, with complex features built upon simple ones.

An important challenge in deploying ANNs in practice is their architecture design, since the ANN architecture directly influences the learnt representations and thus the performance. Typically, it takes researchers a huge amount of time through much trial-and-error to find a good architecture because the search space is exponentially large with respect to many of its hyperparameters. As an example, consider a convolutional neural network (CNN) often used in image recognition tasks. Its various hyperparameters, such as depth, number of filters in each layer, kernel size, how feature maps are connected, etc., need to be determined when designing an architecture. Improvements in such architectures often take several years of effort, as evidenced by the evolution of various architectures for the ImageNet dataset: AlexNet, GoogleNet, ResNet, and DenseNet.

Another challenge ANNs pose is that to obtain their high accuracy, they need to be designed with a large number of parameters. This negatively impacts both the training and inference times. For example, modern deep CNNs often have millions of parameters and take days to train even with powerful graphics processing units (GPUs). However, making the ANN models compact and energy-efficient may enable them to be moved from the cloud to the edge, leading to benefits in communication energy, network bandwidth, and security. The challenge is to do so without degrading accuracy.

As the number of features or dimensions of the dataset increases, in order to generalize accurately, exponentially more data is needed. This is another challenge which is referred to as the curse of dimensionality. Hence, one way to reduce the need for large amounts of data is to reduce the dimensionality of the dataset. In addition, with the same amount of data, by reducing the number of features, the accuracy of the inference model may also improve to a degree. However, beyond a certain point, which is dataset-dependent, reducing the number of features may lead to loss of information, which may lead to inferior classification results.

At least these problems pose a significant design challenge in obtaining compact and accurate neural networks.

### SUMMARY OF THE INVENTION

According to various embodiments, a method for generating a compact and accurate neural network for a dataset is disclosed. The method includes providing an initial neural network architecture; performing a dataset modification on the dataset, the dataset modification including reducing dimensionality of the dataset; performing a first compression step on the initial neural network architecture that results in a compressed neural network architecture, the first compression step including reducing a number of neurons in one or more layers of the initial neural network architecture based on a feature compression ratio determined by the reduced dimensionality of the dataset; and performing a second compression step on the compressed neural network architecture, the second compression step including one or more of iteratively growing connections, growing neurons, and pruning connections until a desired neural network architecture has been generated.

According to various embodiments, a system for generating a compact and accurate neural network for a dataset is disclosed. The system includes one or more processors configured to provide an initial neural network architecture; perform a dataset modification on the dataset, the dataset modification including reducing dimensionality of the dataset; perform a first compression step on the initial neural network architecture that results in a compressed neural network architecture, the first compression step including reducing a number of neurons in one or more layers of the initial neural network architecture based on a feature compression ratio determined by the reduced dimensionality of the dataset; and perform a second compression step on the compressed neural network architecture, the second compression step including one or more of iteratively growing connections, growing neurons, and pruning connections until a desired neural network architecture has been generated.

According to various embodiments, a non-transitory computer-readable medium having stored thereon a computer program for execution by a processor configured to perform a method for generating a compact and accurate neural network for a dataset is disclosed. The method includes providing an initial neural network architecture; performing a dataset modification on the dataset, the dataset modification including reducing dimensionality of the dataset; performing a first compression step on the initial neural network architecture that results in a compressed neural network architecture, the first compression step including reducing a number of neurons in one or more layers of the initial neural network architecture based on a feature compression ratio determined by the reduced dimensionality of the dataset; performing a second compression step on the compressed neural network architecture, the second compression step including one or more of iteratively growing connections, growing neurons, and pruning connections until a desired neural network architecture has been generated.

Various other features and advantages will be made apparent from the following detailed description and the drawings.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only exemplary embodiments of the invention and are not, therefore, to be considered to be limiting its scope, the invention will be described and explained with additional specificity and detail through the use of the accompanying drawings, in which:

FIG. 1 depicts a block diagram of a system for SCANN or DR+SCANN according to an embodiment of the present invention;

FIG. 2 depicts a diagram illustrating hidden layers of hidden neurons according to an embodiment of the present invention;

FIG. 3 depicts a methodology for automatic architecture synthesis according to an embodiment of the present invention;

FIG. 4 depicts a diagram of architecture synthesis according to an embodiment of the present invention;

FIG. 5 depicts a methodology for connection growth according to an embodiment of the present invention;

FIG. 6 depicts a methodology for neuron growth according to an embodiment of the present invention;

FIG. 7 depicts a methodology for connection pruning according to an embodiment of the present invention;

FIG. 8 depicts a diagram of training schemes according to an embodiment of the present invention;

FIG. 9 depicts a block diagram of DR+SCANN according to an embodiment of the present invention;

FIG. 10 depicts a diagram of neural network compression according to an embodiment of the present invention;

FIG. 11 depicts a table of dataset characteristics according to an embodiment of the present invention;

FIG. 12 depicts a table comparing different training schemes according to an embodiment of the present invention;

FIG. 13 depicts a table showing test accuracy according to an embodiment of the present invention;

FIG. 14 depicts a table showing neural network parameters according to an embodiment of the present invention; and

FIG. 15 depicts a table showing inference energy consumption according to an embodiment of the present invention.

### DETAILED DESCRIPTION OF THE INVENTION

Artificial neural networks (ANNs) have become the driving force behind recent artificial intelligence (AI) research. With the help of a vast amount of training data, neural networks can perform better than traditional machine learning algorithms in many applications, such as image recognition, speech recognition, and natural language processing. An important problem with implementing a neural network is the design of its architecture. Typically, such an architecture is obtained manually by exploring its hyperparameter space and kept fixed during training. The architecture that is selected is the one that performs the best on a hold-out validation set. This approach is both time-consuming and inefficient as it is in essence a trial-and-error process. Another issue is that modern neural networks often contain millions of parameters, whereas many applications require small inference models due to imposed resource constraints, such as energy constraints on battery-operated devices. Also, whereas ANNs have found great success in big-data applications, there is also significant interest in using ANNs for medium- and small-data applications that can be run on energy-constrained edge devices. However, efforts to migrate ANNs to such devices typically entail a significant loss of classification accuracy.

To address these challenges, generally disclosed herein is a neural network synthesis system and method, referred to as SCANN, that can generate compact neural networks without loss in accuracy for small and medium-size datasets. With the help of three operations, connection growth, neuron growth, and connection pruning, SCANN synthesizes an arbitrary feed-forward neural network with arbitrary depth. These neural networks do not necessarily have a multilayer perceptron structure. SCANN allows skipped connections, instead of enforcing a layer-by-layer connection structure. SCANN encapsulates three synthesis methodologies that apply a repeated grow-and-prune paradigm to three architectural starting points. Dimensionality reduction methods are also implemented to reduce the feature size of the datasets, so as to alleviate the curse of dimensionality. The approach generally includes three steps: dataset dimensionality reduction, neural network compression in each layer, and neural network compression with SCANN. The neural network synthesis system and method with dimensionality reduction may by referred to as DR+SCANN.

The efficacy of this approach is demonstrated on a medium-size MNIST dataset by comparing SCANN-synthesized neural networks to a LeNet-5 baseline. Without any loss in accuracy, SCANN generates a 46.3× smaller network than the LeNet-5 Caffe model. The efficiency is also evaluated using dimensionality reduction alongside SCANN on nine small- to medium-size datasets. Using this approach enables reduction of the number of connections in the network by up to 5078.7× (geometric mean: 82.1×), with little to no drop in accuracy. It is also shown that this approach yields neural networks that are much better at navigating the accuracy vs. energy efficiency space. This can enable neural network based inference even for IoT sensors.

General Overview

This section is a general overview of dimensionality reduction and automatic architecture synthesis.

Dimensionality Reduction

The high dimensionality of many datasets used in various applications of machine learning leads to the curse of dimensionality problem. Therefore, dimensionality reduction methods may be used to improve the performance of machine learning models by decreasing the number of features. Some dimensionality reduction methods include but are not limited to Principal Component Analysis (PCA), Kernel PCA, Factor Analysis (FA), Independent Component Analysis (ICA), as well as Spectral Embedding methods. Some graph-based methods include but are not limited to Isomap and Maximum Variance Unfolding. Another nonlimiting example, FeatureNet, uses community detection in small sample size datasets to map high-dimensional data to lower dimensions. Other dimensionality reduction methods include but are not limited to stochastic proximity embedding (SPE), Linear Discriminant Analysis (LDA), and t-distributed Stochastic Neighbor Embedding (t-SNE).

Automatic Architecture Synthesis

There are generally three different categories of automatic architecture synthesis methods: evolutionary algorithm, reinforcement learning algorithm, and structure adaptation algorithm.

Evolutionary Algorithm

As the name implies, evolutionary algorithms are heuristic approaches for architecture synthesis influenced by biological evolution. One of the seminal works in neuroevolution is the NEAT algorithm, which uses direct encoding of every neuron and connection to simultaneously evolve the network architecture and weights through weight mutation, connection mutation, node mutation, and crossover. Extensions of the evolutionary algorithm can be used to generate CNNs.

Reinforcement Learning Algorithm

Reinforcement learning algorithms update architecture synthesis based on rewards received from actions taken. For instance, a recurrent neural network can be used as a controller to generate a string that specifies the network architecture. The performance of the generated network is used on a validation dataset as the reward signal to compute the policy gradient and update the controller. Similarly, the controller can be used with a different defined search space to obtain a building block instead of the whole network. Convolutional cells obtained by learning performed on one dataset can be successfully transferred to architectures for other datasets.

Structure Adaptation Algorithm

Architecture synthesis can be achieved by altering the number of connections and/or neurons in the neural network. A nonlimiting example is network pruning. Structure adaptation algorithms can be constructive or destructive, or both constructive and destructive. Constructive algorithms start from a small neural network and grow it into a larger more accurate neural network. Destructive algorithms start from a large neural network and prune connections and neurons to get rid of the redundancy while maintaining accuracy. A couple nonlimiting examples of this architecture synthesis can generally be found in PCT Application Nos. PCT/US2018/057485 and PCT/US2019/22246, which are herein incorporated by reference in their entirety. One of these applications describes a network synthesis tool that combines both the constructive and destructive approaches in a grow-and-prune synthesis paradigm to create compact and accurate architectures for the MNIST and ImageNet datasets. If growth and pruning are both performed at a specific ANN layer, network depth cannot be adjusted and is fixed throughout training. This problem can be solved by synthesizing a general feed-forward network instead of an MLP architecture, allowing the ANN depth to be changed dynamically during training, to be described in further detail below. The other of these applications combines the grow-and-prune synthesis methodology with hardware-guided training to achieve compact long short-term memory (LSTM) cells. Some other nonlimiting examples include platform-aware search for an optimized neural network architecture, training an ANN to satisfy predefined resource constraints (such as latency and energy consumption) with help from a pre-generated accuracy predictor, and quantization to reduce computations in a network with little to no accuracy drop.

System Overview

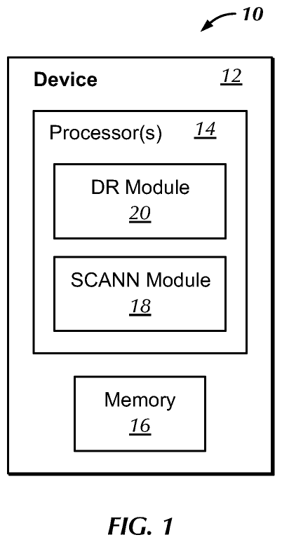

FIG. 1 illustrates a system 10 configured to implement SCANN or DR+SCANN. The system 10 includes a device 12. The device 12 may be implemented in a variety of configurations including general computing devices such as but not limited to desktop computers, laptop computers, tablets, network appliances, and the like. The device 12 may also be implemented as a mobile device such as but not limited to a mobile phone, smart phone, smart watch, or tablet computer. The device 12 can also include network appliances and Internet of Things (IoT) devices as well such as IoT sensors. The device 12 includes one or more processors 14 such as but not limited to a central processing unit (CPU), a graphics processing unit (GPU), or a field programmable gate array (FPGA) for performing specific functions and memory 16 for storing those functions. The processor 14 includes a SCANN module 18 and optional dimensionality reduction (DR) module 20 for synthesizing neural network architectures. The SCANN module 18 and DR module 20 methodology will be described in greater detail below.

It is also to be noted the training process for SCANN or DR+SCANN may be implemented in a number of configurations with a variety of processors (including but not limited to central processing units (CPUs), graphics processing units (GPUs), and field programmable gate arrays (FPGAs)), such as servers, desktop computers, laptop computers, tablets, and the like.

SCANN Synthesis Methodology

This section first proposes a technique so that ANN depth no longer needs to be fixed, then introduces three architecture-changing techniques that enable synthesis of an optimized feedforward network architecture, and last describes three training schemes that may be used to synthesize network architecture.

Depth Change

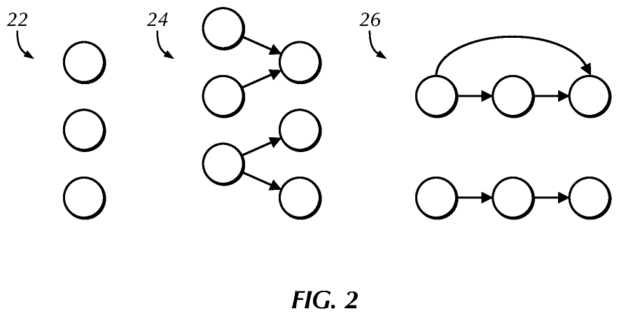

To address the problem of having to fix the ANN depth during training, embodiments of the present invention adopt a general feedforward architecture instead of an MLP structure. Specifically, a hidden neuron can receive inputs from any neuron activated before it (including input neurons), and can feed its output to any neuron activated after it (including output neurons). In this setting, depth is determined by how hidden neurons are connected and thus can be changed through rewiring of hidden neurons. As shown in FIG. 2, depending on how the hidden neurons are connected, they can form one hidden layer 22, two hidden layers 24, or three hidden layers 26. The one hidden layer 22 neural network is due to the neurons not being connected and all of them being in the same layer. For the two hidden layers 24 neural network, the neurons are connected in layers. Similarly, for the three hidden layers 26 neural network, the neurons are connected in three layers. The top one has one skip connection while the bottom one does not.

Overall Workflow

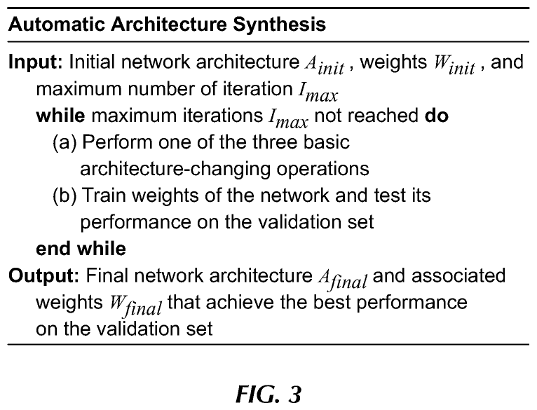

The overall workflow for architecture synthesis is shown in FIG. 3. The synthesis process iteratively alternates between architecture change and weight training. Thus, the network architecture evolves along the way. After a specified number of iterations, the checkpoint that achieves the best performance on the validation set is output as the final network.

Architecture-Changing Operations

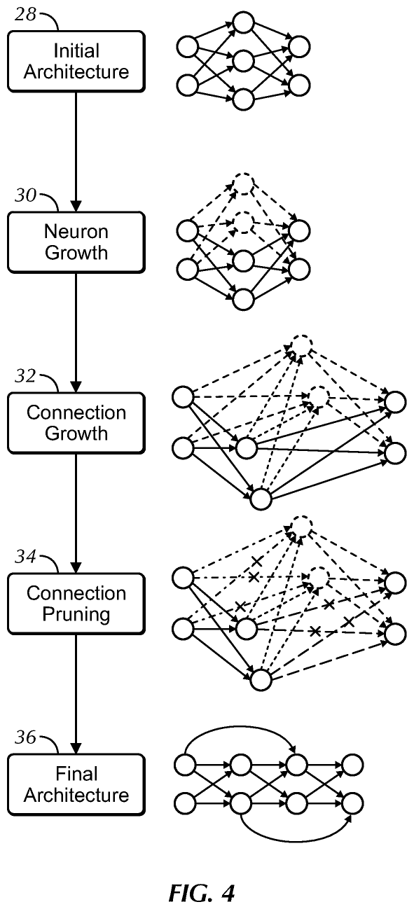

Three general operations, connection growth, neuron growth, and connection pruning, are used to adjust the network architecture, in order to evolve a feed-forward network just through these operations. FIG. 4 shows a simple example in which an MLP architecture with one hidden layer evolves into a non-MLP architecture with two hidden layers with a sequence of the operations mentioned above. It is to be noted the order of operations shown is purely for illustrative purposes and is not intended to be limiting. The operations can be performed in any order any number of times until a final architecture is determined. An initial architecture is first shown at step 28, a neuron growth operation is shown at step 30, a connection growth operation is shown at step 32, a connection pruning operation is shown at step 34, and a final architecture is shown at step 36.

These three operations will now be described in greater detail. The ith hidden neuron is denoted as nᵢ, its activity as xᵢ, and its pre-activity as uᵢ, where xᵢ=f(uᵢ) and f is the activation function. The depth of nᵢ is denoted as Dᵢ and the loss function as L. The connection between nᵢ and nⱼ, where Dᵢ≤D₁, is denoted as ωᵢⱼ. Masks may be used to mask out pruned weights in implementation.

Connection Growth

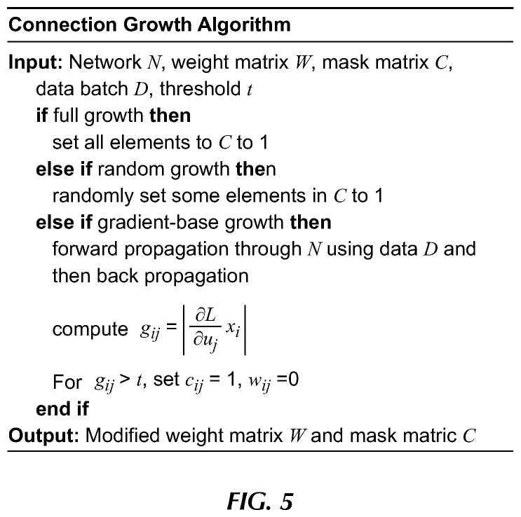

Connection growth adds connections between neurons that are unconnected. The initial weights of all newly added connections are set to 0. Depending on how connections can be added, at least three different methods may be used, as shown in FIG. 5. These are gradient-based growth, full growth, and random growth.

Gradient-based growth adds connections that tend to reduce the loss function L significantly. Supposing two neurons nᵢ and nⱼ are not connected and Dᵢ≤Dⱼ, then gradient-based growth adds a new connection ωᵢⱼ if

$$\vert \frac{\partial L}{\partial {u}_{j}} {x}_{i} \vert$$

is large based on a predetermined threshold, for example, adding the top 20 percent of the connections based on the gradients.

Full growth restores all possible connections to the network.

Random growth randomly picks some inactive connections and adds them to the network.

Neuron Growth

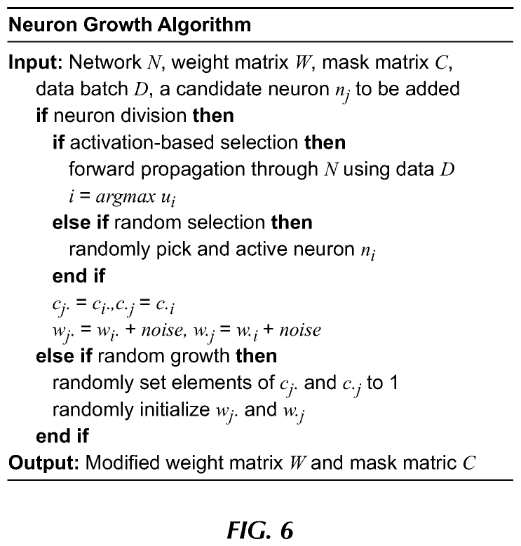

Neuron growth adds new neurons to the network, thus increasing network size over time. There are at least two possible methods for doing this, as shown in FIG. 6.

For the first method, drawing an analogy from biological cell division, neuron growth can be achieved by duplicating an existing neuron. To break the symmetry, random noise is added to the weights of all the connections related to this newly added neuron. The specific neuron that is duplicated can be selected in at least two ways. Activation-based selection selects neurons with a large activation for duplication and random selection randomly selects neurons for duplication. Large activation is determined based on a predefined threshold, for example, the top 30% of neurons, in terms of their activation, are selected for duplication.

For the second method, instead of duplicating existing neurons, new neurons with random initial weights and random initial connections with other neurons may be added to the network.

Connection Pruning

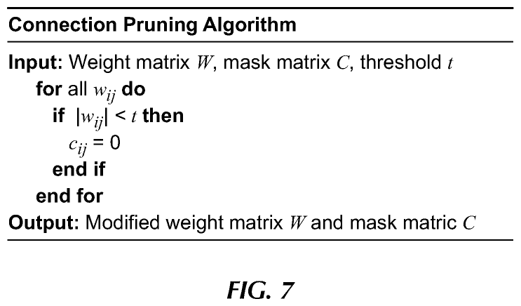

Connection pruning disconnects previously connected neurons and reduces the number of network parameters. If all connections associated with a neuron are pruned, then the neuron is removed from the network. As shown in FIG. 7, one method for pruning connections is to remove connections with a small magnitude. Small magnitude is based on a predefined threshold. The rationale behind it is that since small weights have a relatively small influence on the network, ANN performance can be restored through retraining after pruning.

Training Schemes

Depending on how the initial network architecture Aᵢₙᵢₜ and the three operations described above are chosen, one or more of three training schemes can be adopted.

Scheme A

Scheme A is a constructive approach, where the network size is gradually increased from an initially smaller network. This can be achieved by performing connection and neuron growth more often than connection pruning or carefully selecting the growth and pruning rates, such that each growth operation grows a larger number of connections and neurons, while each pruning operation prunes a smaller number of connections.

Scheme B

Scheme B is a destructive approach, where the network size is gradually decreased from an initially over-parametrized network. There are at least two possible ways to accomplish this. First, a small number of network connections can be iteratively pruned and then the weights can be trained. This gradually reduces network size and finally results in a small network after many iterations. Another approach is that, instead of pruning the network gradually, the network can be aggressively pruned to a substantially smaller size. However, to make this approach work, the network needs to be repeatedly pruned and then the network needs to be grown back, rather than performing a one-time pruning.

Scheme C

Scheme B can also work with MLP architectures, with only a small adjustment in connection growth such that only connections between adjacent layers are added and not skipped connections. For clarity, MLP-based Scheme B will be referred to as Scheme C. Scheme C can also be viewed as an iterative version of a dense-sparse-dense technique, with the aim of generating compact networks instead of improving performance of the original architecture. It is to be noted that for Scheme C, the depth of the neural network is fixed.

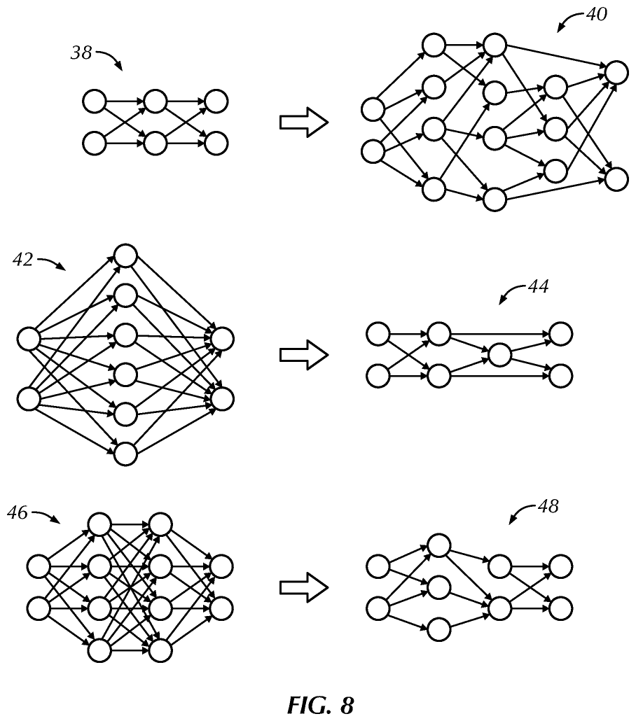

FIG. 8 shows example of the initial and final architectures for each scheme. An initial architecture 38 and a final architecture 40 is shown for Scheme A, an initial architecture 42 and a final architecture 44 is shown for Scheme B, and an initial architecture 46 and a final architecture 48 is shown for Scheme C. Both Schemes A and B evolve general feedforward architectures, thus allowing network depth to be changed during training. Scheme C evolves an MLP structure, thus keeping the depth fixed.

Dimensionality Reduction+SCANN

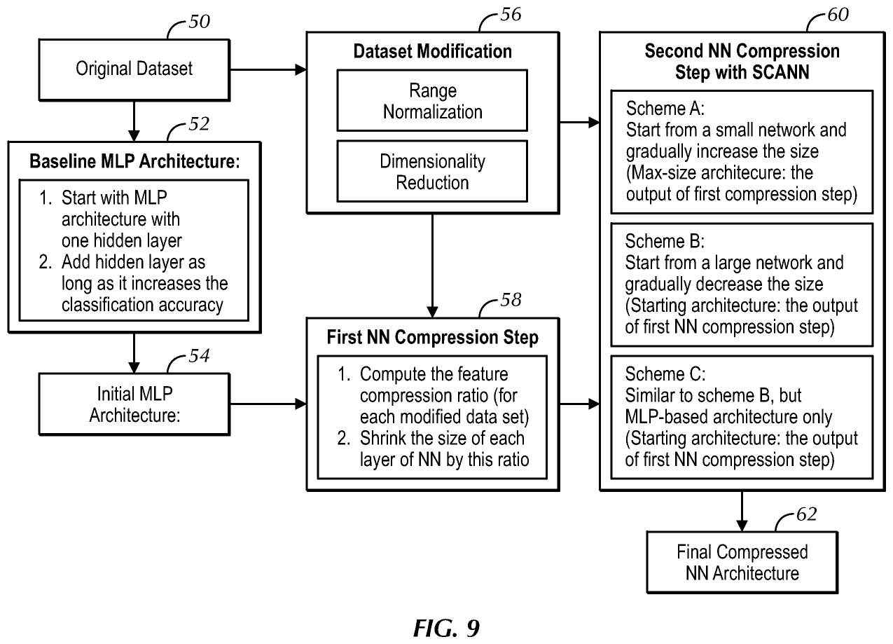

This section illustrates a methodology to synthesize compact neural networks by combining dimensionality reduction (DR) and SCANN, referred to herein as DR+SCANN. FIG. 9 shows a block diagram of the methodology, starting with an original dataset 50. The methodology begins by obtaining an accurate baseline architecture at step 52 by progressively increasing the number of hidden layers. This leads to an initial MLP architecture 54. The other steps are a dataset modification step 56, a first neural network compression step 58, and a second neural network compression step 60, to be described in the following sections. A final compressed neural network architecture 62 results from these steps.

Dataset Modification 56

Dataset modification entails normalizing the dataset and reducing its dimensionality. All feature values are normalized to the range [0,1]. Reducing the number of features in the dataset is aimed at alleviating the effect of the curse of dimensionality and increasing data classifiability. This way, an N×d-dimensional dataset is mapped onto an N×k-dimensional space, where k<d, using one or more dimensionality reduction methods. A number of nonlimiting methods are described below as examples.

Random projection (RP) methods are used to reduce data dimensionality based on the lemma that if the data points are in a space of sufficiently high dimension, they can be projected onto a suitable lower dimension, while approximately maintaining inter-point distances. More precisely, this lemma shows that the distance between the points change only by a factor of (1±ε) when they are randomly projected onto the subspace of

$$( log \frac{n}{{ɛ}^{2}} )$$

dimensions for any 0<ε<1. The RP matrix Φ can be generated in several ways. Four RP matrices are described here as nonlimiting examples.

One approach is to generate Φ using a Gaussian distribution. In this case, the entries ϕᵢⱼ are i.i.d. samples drawn from a Gaussian distribution

$$( 0 , \frac{1}{k} ) .$$

Another RP matrix can be obtained by sampling entries from [symbol] (0,1). These entries are shown below:

$${ϕ}_{ij}^{1} \sim ( 0 , \frac{1}{k} )$$

$${ϕ}_{ij}^{2} \sim ( 0 , 1 )$$

Several other sparse RP matrices can be utilized. Two are as follows, where ϕᵢⱼ's are independent random variables that are drawn based on the following probability distributions:

$${ϕ}_{ij}^{3} = \{ \begin{matrix}+ 1 with probability \frac{1}{2} \\ - 1 with probability \frac{1}{2}\end{matrix} \\ {ϕ}_{ij}^{4} = \sqrt{\frac{3}{k}} \{ \begin{matrix}+ 1 with probability \frac{1}{6} \\ 0 with probability \frac{2}{3} \\ - 1 with probability \frac{1}{6}\end{matrix}$$

The other dimensionality reduction methods that can be used include but are not limited to principal component analysis (PCA), polynomial kernel PCA, Gaussian kernel PCA, factor analysis (FA), isomap, independent component analysis (ICA), and spectral embedding.

Neural Network Compression in each Layer 58

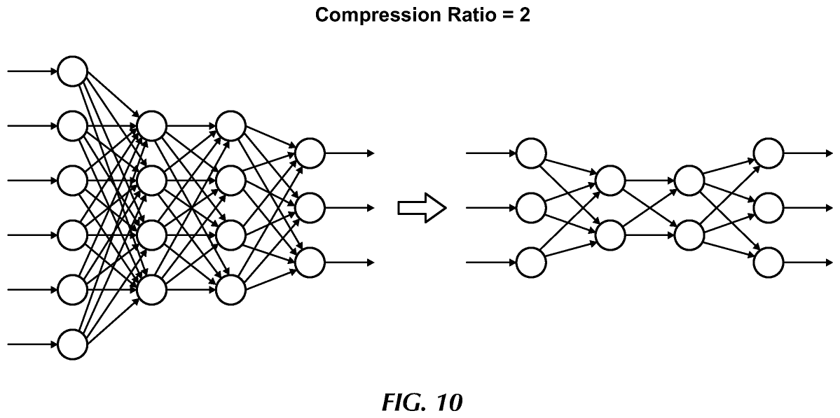

Dimensionality reduction maps the dataset into a vector space of lower dimension. As a result, as the number of features reduces, the number of neurons in the input layer of the neural network decreases accordingly. However, since the dataset dimension is reduced, one might expect the task of classification to become easier. This means the number of neurons in all layers can be reduced, not just the input layer. This step reduces the number of neurons in each layer of the neural network by the feature compression ratio in the dimensionality reduction step, except for the output layer. Feature compression ratio is the ratio by which the number of features in the dataset are reduced. The number of neurons in each layers are reduced by the same ratio as the feature compression ratio. FIG. 10 shows an example of this process of compressing neural networks in each layer. While a compression ratio of 2 is shown, that ratio number is only an example and is not intended to be limiting. This dimensionality reduction stage may be referred to as DR.

Neural Network Compression with SCANN 60

Several neural network architectures obtained from the output of the first neural network compression step are input to SCANN. These architectures correspond to the best three classification accuracies, as well as the three most compressed networks that meet the baseline accuracy of the initial MLP architecture, as evaluated on the validation set. SCANN uses the corresponding reduced-dimension dataset.

In Scheme A, the maximum number of connections in the networks should be set. This value is set to the number of connections in the neural network that results from the first compression step 58. This way, the final neural network will become smaller.

Schemes B and C should have the maximum number of neurons and the maximum number of connections be initialized. In addition, in these two training schemes, the final number of connections in the network also should be set. Furthermore, the number of layers in the MLP architecture synthesized by Scheme C should be predetermined. These parameters are initialized using the network architecture that is output from the first neural network compression step 58.

Experimental Results

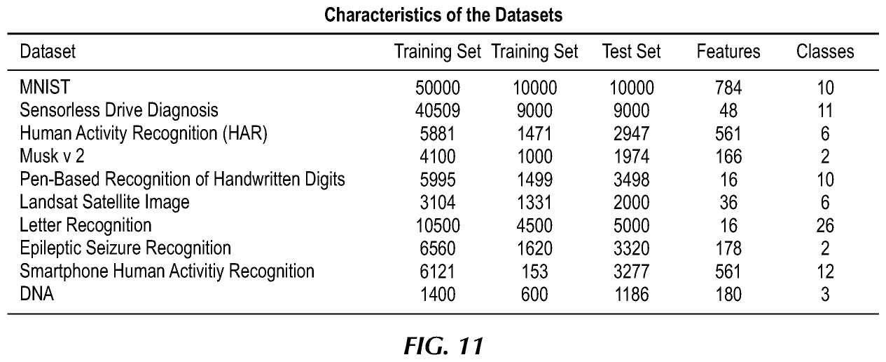

This evaluates the performance of embodiments of SCANN and DR+SCANN on several small- to medium-size datasets. FIG. 11 shows the characteristics of these datasets. The evaluation results are divided into two parts. The first part discusses results obtained by SCANN when applied to the widely used MNIST dataset. Compared to related work, SCANN generates neural networks with better classification accuracy and fewer parameters. The second part shows the results of experiments on nine other datasets. It is demonstrated that the ANNs generated by SCANN are very compact and energy-efficient, while maintaining performance. These results open up opportunities to use SCANN-generated ANNs in energy-constrained edge devices and IoT sensors.

Experiments with MNIST

MNIST is a dataset of handwritten digits, containing 60000 training images and 10000 test images. 10000 images are set aside from the training set as the validation set. The Lenet-5 Caffe model is adopted. For Schemes A and B, the feed-forward part of the network is learnt by SCANN, whereas the convolutional part is kept the same as in the baseline (Scheme A does not make any changes to the baseline, but Scheme B prunes the connections). For Scheme C, SCANN starts with the baseline architecture, and only learns the connections and weights, without changing the depth of the network. All experiments use the stochastic gradient descent (SGD) optimizer with a learning rate of 0.03, momentum of 0.9, and weight decay of 1e-4. No other regularization technique like dropout or batch normalization is used. Each experiment is run five times and the average performance is reported.

The LeNet-5 Caffe model contains two convolutional layers with 20 and 50 filters, and also one fully-connected hidden layer with 500 neurons. For Scheme A, 400 hidden neurons are started with in the feed-forward part, 95 percent of the connections are randomly pruned out in the beginning, and then a sequence of connection growth is iteratively performed that activates 30 percent of all connections and connection pruning that prunes 25 percent of existing connections. For Scheme B, 400 hidden neurons are started with in the feed-forward part and a sequence of connection pruning is iteratively performed such that 3.3K connections are left in the convolutional part and 16K connections are left in the feedforward part, and connection growth is then performed such that 90 percent of all connections are restored. For Scheme C, a fully connected baseline architecture is started with and a sequence of connection pruning is iteratively performed such that 3.3K connections are left in the convolutional part and 6K connections are left in the feed-forward part, and connection growth is then performed such that all connections are restored.

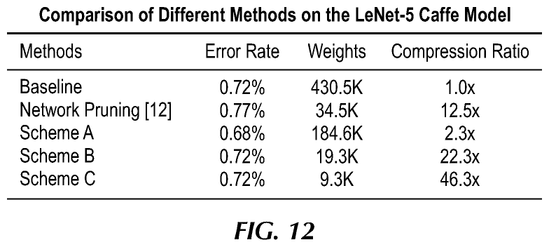

FIG. 12 summarizes the results. The baseline error rate is 0.72% with 430.5K parameters. The most compressed model generated by SCANN contains only 9.3K parameters (with a compression ratio of 46.3× over the baseline), achieving a 0.72% error rate when using Scheme C. Scheme A obtains the best error rate of 0.68%, however, with a lower compression ratio of 2.3×.

Experiments with Other Datasets

Though SCANN demonstrates very good compression ratios for LeNets on the medium-size MNIST dataset at similar or better accuracy, one may ask if SCANN can also generate compact neural networks from other medium and small datasets. To answer this question, nine other datasets are experimented with and evaluation results are presented on these datasets.

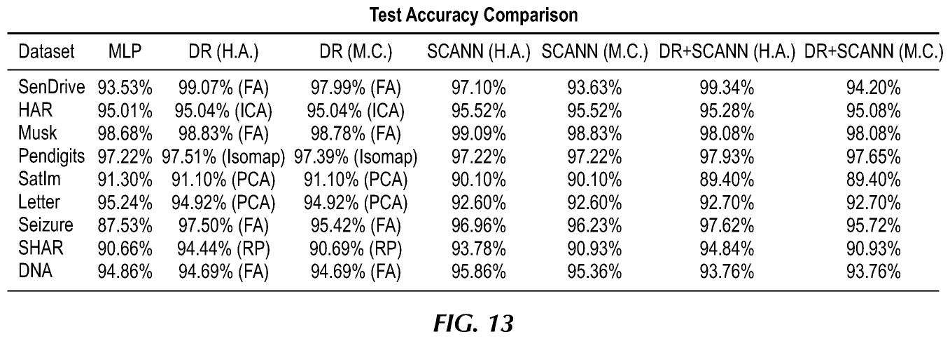

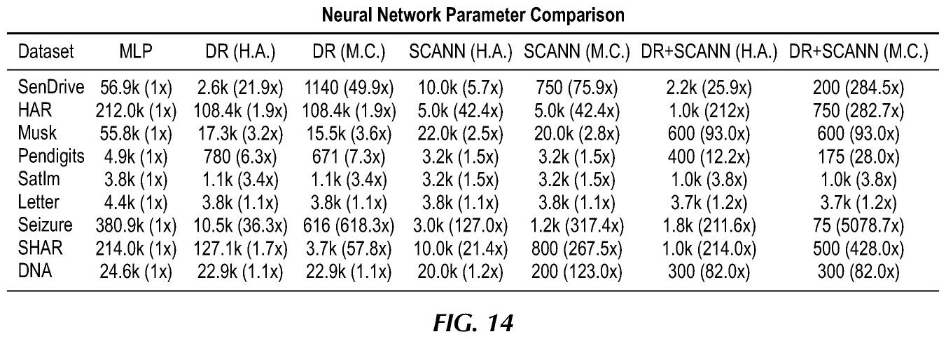

SCANN experiments are based on the Adam optimizer with a learning rate of 0.01 and weight decay of 1e-3. Results obtained by DR+SCANN are compared with those obtained by only applying SCANN, and also DR without using SCANN in a secondary compression step. FIG. 13 shows the classification accuracy obtained. The MLP column shows the accuracy of the MLP baseline for each dataset. For all the other methods, two columns are presented, the left of which shows the highest achieved accuracy (H.A.) whereas the right one shows the result for the most compressed network (M.C.). Furthermore, for the DR columns, the dimensionality reduction method employed is shown in parentheses. FIG. 14 shows the number of parameters in the network for the corresponding columns in FIG. 13.

SCANN-generated networks show improved accuracy for six of the nine datasets, as compared to the MLP baseline. The accuracy increase is between 0.41% to 9.43%. These results correspond to networks that are 1.2× to 42.4× smaller than the base architecture. Furthermore, DR+SCANN shows improvements on the highest classification accuracy on five out of the nine datasets, as compared to SCANN-generated results.

In addition, SCANN yields ANNs that achieve the baseline accuracy with fewer parameters on seven out of the nine datasets. For these datasets, the results show a connection compression ratio between 1.5× to 317.4×. Moreover, as shown in FIGS. 13 and 14, combining dimensionality reduction with SCANN helps achieve higher compression ratios. For these seven datasets, DR+SCANN can meet the baseline accuracy with a 28.0× to 5078.7× smaller network. This shows a significant improvement over the compression ratio achievable by just using SCANN.

The performance of applying DR without the benefit of the SCANN synthesis step is also reported. While these results show improvements, DR+SCANN can be seen to have much more compression power, relative to when DR and SCANN are used separately. This points to a synergy between DR and SCANN.

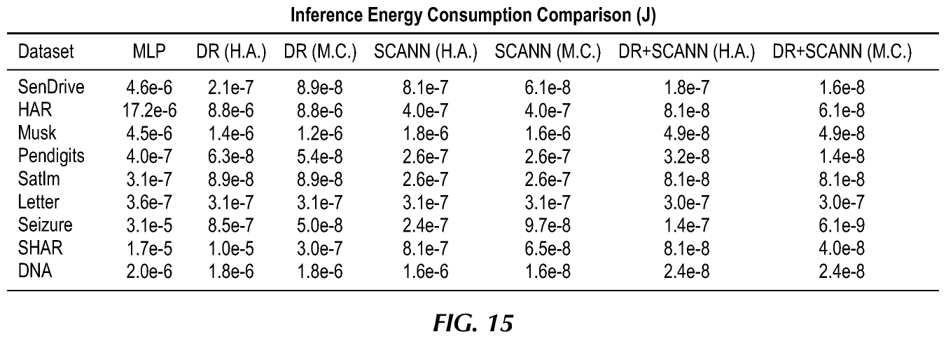

Although the classification performance is of great importance, in applications where computing resources are limited, e.g., in battery-operated devices, energy efficiency might be one of the most important concerns. Thus, energy performance of the algorithms should also be taken into consideration in such cases. To evaluate the energy performance, the energy consumption for inference is calculated based on the number of multiply accumulate and comparison (MAC) operations and the number of SRAM accesses. For example, a multiplication of two matrices of size M×N and N×K would require (M·N·K) MAC operations and (2·M·N·K) SRAM accesses. In their model, a single MAC operation, SRAM access, and comparison operation implemented in a 130 nm CMOS process (which may be an appropriate technology for many IoT sensors) consumes 11.8 pJ, 34.6 pJ and 6.16 fJ, respectively. FIG. 15 shows the energy consumption estimates per inference for the corresponding models discussed in FIGS. 13 and 14. DR+SCANN can be seen to have the best overall energy performance. Except for the Letter dataset (for which the energy reduction is only 17 percent), the compact ANNs generated by DR+SCANN consume one to four orders of magnitude less energy than the baseline MLP models. Thus, this synthesis methodology is suitable for heavily energy-constrained devices, such as IoT sensors.

### CONCLUSION

The advantages of SCANN and DR+SCANN are derived from its core benefit: the network architecture is allowed to dynamically evolve during training. This benefit is not directly available in several other existing automatic architecture synthesis techniques, such as the evolutionary and reinforcement learning based approaches. In those methods, a new architecture, whether generated through mutation and crossover in the evolutionary approach or from the controller in the reinforcement learning approach, needs to be fixed during training and trained from scratch again when the architecture is changed.

However, human learning is incremental. The brain gradually changes based on the presented stimuli. For example, studies of the human neocortex have shown that up to 40 percent of the synapses are rewired every day. Hence, from this perspective, SCANN takes inspiration from how the human brain evolves incrementally. SCANN's dynamic rewiring can be easily achieved through connection growth and pruning.

Comparisons between SCANN and DR+SCANN show that the latter results in a smaller network in nearly all the cases. This is due to the initial step of dimensionality reduction. By mapping data instances into lower dimensions, it reduces the number of neurons in each layer of the neural network, without degrading performance. This helps feed a significantly smaller neural network to SCANN. As a result, DR+SCANN synthesizes smaller networks relative to when only SCANN is used.

As such, embodiments generally disclosed herein are a system and method for a synthesis methodology that can generate compact and accurate neural networks. It solves the problem of having to fix the depth of the network during training that prior synthesis methods suffer from. It is able to evolve an arbitrary feed-forward network architecture with the help of three general operations: connection growth, neuron growth, and connection pruning. Experiments on the MNIST dataset show that, without loss in accuracy, SCANN generates a 46.3× smaller network than the LeNet-5 Caffe model. Furthermore, by combining dimensionality reduction with SCANN synthesis, significant improvements in the compression power of this framework was shown. Experiments with several other small to medium datasets show that SCANN and DR+SCANN can provide a good tradeoff between accuracy and energy efficiency in applications where computing resources are limited.

It is understood that the above-described embodiments are only illustrative of the application of the principles of the present invention. The present invention may be embodied in other specific forms without departing from its spirit or essential characteristics. All changes that come within the meaning and range of equivalency of the claims are to be embraced within their scope. Thus, while the present invention has been fully described above with particularity and detail in connection with what is presently deemed to be the most practical and preferred embodiment of the invention, it will be apparent to those of ordinary skill in the art that numerous modifications may be made without departing from the principles and concepts of the invention as set forth in the claims.

1. A method for generating a compact and accurate neural network for a dataset, the method comprising:
providing an initial neural network architecture;
performing a dataset modification on the dataset, the dataset modification comprising reducing dimensionality of the dataset;
performing a first compression step on the initial neural network architecture that results in a compressed neural network architecture, the first compression step comprising reducing a number of neurons in one or more layers of the initial neural network architecture based on a feature compression ratio determined by the reduced dimensionality of the dataset; and
performing a second compression step on the compressed neural network architecture, the second compression step comprising iteratively growing at least one of connections and neurons to increase a size of the compressed neural network architecture and iteratively pruning connections to decrease the size of the compressed neural network architecture until a desired neural network architecture has been generated.

2. The method of claim 1, further comprising adding one or more hidden layers to the initial neural network architecture.

3. The method of claim 1, wherein dataset modification further comprises normalizing the dataset.

4. The method of claim 1, wherein reducing dimensionality of the dataset comprises one or more of random projection, principal component analysis (PCA), polynomial kernel PCA, Gaussian kernel PCA, factor analysis, isomap, independent component analysis, and spectral embedding.

5. The method of claim 1, wherein the first compression step further comprises computing the feature compression ratio.

6. (canceled)

7. (canceled)

8. The method of claim 1, wherein growing connections further comprises growing connections only between adjacent layers.

9. The method of claim 1, wherein growing connections is based on one of gradient-based growth, full growth, and random growth.

10. The method of claim 1, wherein growing neurons is based on one of duplication and random addition.

11. The method of claim 1, wherein pruning connections is based on magnitude-based pruning.

12. A system for generating a compact and accurate neural network for a dataset, the system comprising one or more processors configured to:
provide an initial neural network architecture;
perform a dataset modification on the dataset, the dataset modification comprising reducing dimensionality of the dataset;
perform a first compression step on the initial neural network architecture that results in a compressed neural network architecture, the first compression step comprising reducing a number of neurons in one or more layers of the initial neural network architecture based on a feature compression ratio determined by the reduced dimensionality of the dataset; and
perform a second compression step on the compressed neural network architecture, the second compression step comprising iteratively growing at least one of connections and neurons to increase a size of the compressed neural network architecture and iteratively pruning connections to decrease the size of the compressed neural network architecture until a desired neural network architecture has been generated.

13. The system of claim 12, wherein the one or more processors are further configured to add one or more hidden layers to the initial neural network architecture.

14. The system of claim 12, wherein dataset modification further comprises normalizing the dataset.

15. The system of claim 12, wherein reducing dimensionality of the dataset comprises one or more of random projection, principal component analysis (PCA), polynomial kernel PCA, Gaussian kernel PCA, factor analysis, isomap, independent component analysis, and spectral embedding.

16. The system of claim 12, wherein the first compression step further comprises computing the feature compression ratio.

17. (canceled)

18. (canceled)

19. The system of claim 12, wherein growing connections further comprises growing connections only between adjacent layers.

20. The system of claim 12, wherein growing connections is based on one of gradient-based growth, full growth, and random growth.

21. The system of claim 12, wherein growing neurons is based on one of duplication and random addition.

22. The system of claim 12, wherein pruning connections is based on magnitude-based pruning.

23. A non-transitory computer-readable medium having stored thereon a computer program for execution by a processor configured to perform a method for generating a compact and accurate neural network for a dataset, the method comprising:
providing an initial neural network architecture;
performing a dataset modification on the dataset, the dataset modification comprising reducing dimensionality of the dataset;
performing a first compression step on the initial neural network architecture that results in a compressed neural network architecture, the first compression step comprising reducing a number of neurons in one or more layers of the initial neural network architecture based on a feature compression ratio determined by the reduced dimensionality of the dataset;
performing a second compression step on the compressed neural network architecture, the second compression step comprising iteratively growing at least one of connections and neurons to increase a size of the compressed neural network architecture and iteratively pruning connections to decrease the size of the compressed neural network architecture until a desired neural network architecture has been generated.

24. The computer-readable medium of claim 23, wherein the method further comprises adding one or more hidden layers to the initial neural network architecture.

25. The computer-readable medium of claim 23, wherein dataset modification further comprises normalizing the dataset.

26. The computer-readable medium of claim 23, wherein reducing dimensionality of the dataset comprises one or more of random projection, principal component analysis (PCA), polynomial kernel PCA, Gaussian kernel PCA, factor analysis, isomap, independent component analysis, and spectral embedding.

27. The computer-readable medium of claim 23, wherein the first compression step further comprises computing the feature compression ratio.

28. (canceled)

29. (canceled)

30. The computer-readable medium of claim 23, wherein growing connections further comprises growing connections only between adjacent layers.

31. The computer-readable medium of claim 23, wherein growing connections is based on one of gradient-based growth, full growth, and random growth.

32. The computer-readable medium of claim 23, wherein growing neurons is based on one of duplication and random addition.

33. The computer-readable medium of claim 23, wherein pruning connections is based on magnitude-based pruning.
